(19) United States
(12) Patent Application Publication
(10) Pub. No.: US 2025/0002620 A1
(43) Pub. Date: Jan. 2, 2025

(54) LINEAR LOW DENSITY POLYETHYLENE COPOLYMER

(71) Applicant: Univation Technologies, LLC, Houston, TX (US)

(72) Inventors: Bo Liu, Lake Jackson, TX (US); Nitin K. Borse, Pearland, TX (US); Feng Chen, Shanghai (CN); Wesley R. Mariott, Manvel, TX (US); Jesse C. Beilhart, South Charleston, WV (US); Charles D. Lester, South Charleston, WV (US)

(21) Appl. No.: 18/576,429

(22) PCT Filed: Sep. 23, 2021
(86) PCT No.: PCT/CN2021/119799

§ 371 Date: Jan. 4, 2024

(51) Int. Cl. C08F 210/16; B29C 48/00; B29C 48/10; B29K 23/00

(52) U.S. Cl. CPC C08F 210/16; B29C 48/0018; B29C 48/022; B29C 48/10; B29K 2023/0625; B29K 2995/0063; B29K 2995/0088

(57) ABSTRACT

An ethylene-butene LLDPE copolymer that has a mixture of properties useful for films has the following characteristics: (a) The density of the LLDPE copolymer is from 0.910 g/mL to 0.930 g/mL; and (b) The melt index (I₂) of the LLDPE copolymer is from 0.5 g/10 min to 2.7 g/10 min; and (c) The molecular weight distribution (Mw/Mn) of the LLDPE copolymer is at least 4.25; and. (d) The Mz/Mw ratio of the LLDPE copolymer is at least 3.2; and (e) The molecular weight comonomer distribution of the LLDPE copolymer is from −0.1 to −1.0; and (f) The storage modulus (G′) of the material is from 90 Pa to 115 Pa when the loss modulus (G″) is 1000 Pa.

### FIELD

This invention relates to linear low-density polyethylene copolymers and films.

### DESCRIPTION OF RELATED ART

It is known to make linear low-density polyethylene copolymers using Ziegler-Natta catalysts.

It is further known to produce films of linear low-density polyethylene copolymers (LLDPE copolymers), such as by cast film extrusion or blown film extrusion. See, for example, LyondellBasell, A Guide to Polyolefin Film Extrusion, Publication 6047/1004 (available at lyb.com) and Qenos Pty, Ltd., Film Extrusion and Conversion—Technical Guide (July 2015) (available at qenos.com). The films are often used for packaging applications, such as food packaging.

LLDPE copolymers are characterized by measurement of many different physical, chemical and structural qualities. Common measurements include:
Density.
Melt viscosity is measured as a melt index (I₂), a flow index (I₂₁) and/or a melt-flow ratio (I₂₁/I₂). Measurement techniques are described in ASTM D1238-13, Standard Test Method for Melt Flow Rates of Thermoplastics by Extrusion Platometer.
Average polymer molecular weight is measured as a number average molecular weight (Mₙ), a weight average molecular weight (M_{w}) and a “z-average molecular weight” (M_{z}). The ratios of these measurements Mw/Mn (also called “polydispersity index” or “molecular weight distribution”) and Mz/Mw are often calculated. The molecular weight averages and their ratios are described in publications such as Ward, “Molecular Weight and Molecular Weight Distributions in Synthetic Polymers”, 58 Journal of Chemical Education 867-879 (November 1981).
Comonomer content may be measured such as by measuring short-chain branches per 1000 carbon atoms, which is described in publications such as ASTM 5017-17, Standard Test Method for Determination of Linear Low Density Polyethylene (LLDPE) Composition by Carbon-13 Nuclear Magnetic Resonance, ASTM International, West Conshohocken, PA, 2017, www.astm.org.
Comonomer is often distributed unequally throughout an LLDPE copolymer, with higher molecular weight and lower molecular weight fractions containing different levels of comonomer. The distribution can be measured as a “Molecular Weight Comonomer Distribution Index” (MWCDI), which is described in the following US Patents and Patent Publications: 2017/0129229 A1 (Para. [0153]-[0164]), 2020/0325313 A1 (Para. [0038]-[0049]) and 11,040,523 B2 (col. 21-24). For example, an MWCDI of 0 indicates even distribution of comonomer, a positive MWCDI indicates higher levels of comonomer in the higher-molecular weight fractions of the copolymer, and a negative MWCDI higher levels of comonomer in the higher-molecular weight fractions of the copolymer. (An alternative means to analyze comonomer distribution uses elution fractionation in the “Improved Comonomer Content Distribution” (iCCD) Analysis, which is described in US Patent Publication 2021/0040295 A1 (Para. [0171]-[0181]) and in the publication: Cong et al., A New Technique for Characterizing Comonomer Distribution in Polyolefins: High-Temperature Thermal Gradient Interaction Chromatography (HT-TGIC), 44 Macromolecules 3062-3072 (Mar. 28, 2011).)
Viscoelastic properties of the LLDPE copolymer can be measured using dynamic mechanical spectroscopy (DMS) to provide storage modulus (G′), loss modulus (G″) and the damping factor tan δ (G″/G′). These techniques and measurements are described in publications such as Dunson. “Characterization of Polymers using Dynamic Mechanical Analysis (DMA)” Paper M-022717 published by Eurofins Scientific (2017) and available at http://www.eag.com and Franck, “Viscosity and Dynamic Mechanical Testing”, Paper AN004 published by TA Instruments at http://www.tainstruments.com.

The processability and properties of films can be improved by selecting properties of the underlying polymer. Therefore, it is desirable to provide linear low-density polyethylene that have improved balance of properties for use in film applications.

### SUMMARY

One aspect of the present invention is a linear low density polyethylene copolymer (LLDPE copolymer), comprising units derived from ethylene monomer and butene monomer wherein:
(a) The density of the LLDPE copolymer is from 0.910 g/cm3 to 0.930 g/cm3; and
(b) The melt index (I₂) of the LLDPE copolymer is from 0.5 g/10 min to 2.7 g/10 min; and
(c) The molecular weight distribution (Mw/Mn) of the LLDPE copolymer is at least 4.25; and.
(d) The Mz/Mw ratio of the LLDPE copolymer is at least 3.2; and
(e) The molecular weight comonomer distribution index of the LLDPE copolymer is from −0.1 to −1.0; and
(f) The storage modulus (G′) of the material is from 90 Pa to 115 Pa when the loss modulus (G″) is 1000 Pa.

A second aspect of the present invention is a film that contains the LLDPE copolymer of the present invention.

A third aspect of the present invention is a method of making a blown film, the method comprising melting the LLDPE copolymer to give a melt thereof, extruding the melt through a die configured for forming a bubble to make a bubble of the LLDPE copolymer, and blowing (inflating) the bubble with a film-blowing machine, thereby making the blown film.

### BRIEF DESCRIPTION OF THE DRAWING

FIG. 1 shows the result of hot tack testing for an inventive resin as compared to two comparative resins.

### DETAILED DESCRIPTION

### Processes to Make the LLDPE Copolymer

The LLDPE copolymers of this present invention are polymerized by contacting ethylene monomer and 1-butene comonomer with a catalyst system, and optionally with other reagents and diluents, in a reactor under conditions suitable to cause polymerization of the monomers.

In some embodiments, the monomer mixture contains at least 70 mole percent ethylene monomer or at least 80 mole percent or at least 82 mole percent or at least 85 mole percent. In some embodiments, the monomer mixture contains at least 2 mole percent butene comonomer or at least 4 mole percent or at least 5 mole percent or at least 7 mole percent. (In gas-phase polymerization, the mole ratio of monomers may be determined based on partial pressure.)

Optionally, the monomer mixture may contain additional unsaturated comonomers. Examples of additional comonomers are a-olefin hydrocarbons having from 3 to 12 carbon atoms. In some embodiments, the a-olefin hydrocarbons are linear a-olefin hydrocarbons, which are polymerizable monomers of formula H₂C=C(H)(CH₂)ᵣCH₃, wherein r is a number from 0 to 7. Exemplary additional comonomers include, but are not limited to, propylene, 1-pentene, 1-hexene, 1-heptene, 1-octene, and 4-methyl-1-pentene. In some embodiments, the additional comonomers are selected from the group consisting of 1-hexene and 1-octene, or are 1-hexene. In many embodiments, the monomer mixture contains less than 10 mole percent additional unsaturated comonomers or less than 5 mole percent or less than 2 mole percent. In some embodiments, the monomer mixture consists essentially of ethylene monomer and 1-butene comonomer.

In some embodiments, the reaction mixture further contains elemental hydrogen, which completes the end of terminated polymer chains. The hydrogen to ethylene (H₂/C₂) molar ratio in the reactor varies depending on the molecular weights of the polymers being produced. In some embodiments, the molar ratio of hydrogen to ethylene monomer is at least 0.01 or at least 0.04 or at least 0.06 or at least 0.08 or at least 0.1. In some embodiments, the molar ratio of hydrogen to ethylene monomer is at most 0.3 or at most 0.2 or at most 0.18.

The monomer mixture is contacted with a catalyst system that comprises a primary catalyst and an activator, which are often deposited on a carrier. The catalyst system should be capable of initiating and catalyzing polymerization of the monomer mixture under reaction conditions.

The primary catalyst in the catalyst system contains salts of one or more transition metals of any of the groups IVB-VIII of the periodic table of elements. In single site catalyst systems, the transition metal atoms are complexed with an organic ligand such as a cyclopentadienyl-containing compound. In traditional Ziegler-Natta catalyst systems, the transition metal salts do not have an organic complex. In some embodiments of the polymerization process, the primary catalyst is traditional Ziegler Natta catalyst system containing a titanium halide, such as TiCl3 or TiCl4, and in some embodiments of the polymerization process the titanium halide is deposited on a magnesium halide.

The activator in the catalyst system is a substance, other than the catalyst or one of the substrates, that increases the rate of a catalyzed reaction without itself being consumed. Examples of common activators contain aluminum and/or boron. Some activators may comprise a (C₁-C₄) alkyl-containing aluminum compound or an alkylaluminoxane (alkylalumoxane). The (C₁-C₄) alkyl-containing aluminum compound may independently contain 1, 2, or 3 (C₁-C₄) alkyl groups and 2, 1, or 0 groups each independently selected from chloride atom and (C₁-C₄) alkoxide. Each (C₁-C₄) alkyl may independently be methyl; ethyl; propyl; 1-methylethyl; butyl; 1-methylpropyl; 2-methylpropyl; or 1,1-dimethylethyl. Each (C₁-C₄) alkoxide may independently be methoxide; ethoxide; propoxide; 1-methylethoxide; butoxide; 1-methylpropoxide; 2-methylpropoxide; or 1,1-dimethylethoxide. The (C₁-C₄) alkyl-containing aluminum compound may be triethylaluminum (TEAI), triisobutylaluminum (TIBA), diethylaluminum chloride (DEAC), diethylaluminum ethoxide (DEAE), ethylaluminum dichloride (EADC), or a combination or mixture of any two or more thereof. The alkylaluminoxane may be a methylaluminoxane (MAO), ethylaluminoxane, 2-methylpropyl-aluminoxane, or a modified methylaluminoxane (MMAO). For example, the activator may be methylaluminoxane (MAO), triethylaluminum (TEA), triisobutylaluminum (TIBA), diethylaluminum chloride (DEAC), diethylaluminum ethoxide (DEAE), or ethylaluminum dichloride (EADC).

The carrier material is a material that is inert under polymerization conditions. In many embodiments the carrier material is selected to provide a high surface area and a desired particle size for the completed polymer. Examples of inorganic oxide-type carrier materials are silica, alumina, titania, zirconia, thoria, and mixtures of any two or more of such inorganic oxides. In some embodiments the carrier material is a silica, which may optionally be further treated (such as a fumed silica).

Many primary catalysts and activators are unstable in air, and so they should be contacted and handled under an inert atmosphere such as nitrogen.

A useful catalyst composition is described in Modified Spray-Dried Ziegler-Natta (Pro)Catalyst Systems, PCT Publication 2019/112929 A1 (13 Jun. 2019). The useful system contains titanium-magnesium Ziegler-Natta (pro) catalysts that are modified with a tetrahydrofuran/ethanol modifier, alkyl aluminum activator and a carrier material.

The modified spray-dried Ziegler-Natta primary catalyst system may be characterized by any one or more of limitations (i) to (x): (i) a Mg atom loading of from 2.0 to 10.0 weight percent (wt %), alternatively from 6.0 to 8.5 wt %, alternatively from 6.5 to 8.0 wt %, based on total weight of the ad rem system; (ii) a Mg atom concentration of from 0.82 to 4.11 millimoles Mg atom per gram of the ad rem system (mmol/g), alternatively from 2.0 to 4.0 mmol/g, alternatively 2.47 to 3.50 mmol/g, alternatively from 2.67 to 3.29 mmol/g; (iii) a Ti atom loading of from 0.5 to 5.0 wt %, alternatively from 1.0 to 4.0 wt %, alternatively from 1.5 to 3.5 wt %, based on total weight of the ad rem system; (iv) a Ti atom concentration of from 0.10 to 1.04 millimoles Ti atom per gram of the ad rem system (mmol/g), alternatively from 0.21 to 0.84 mmol/g, alternatively from 0.25 to 0.80 mmol/g, alternatively from 0.31 to 0.73 mmol/g; (v) a Mg atom-to-Ti atom molar ratio from 0.79 to 39.4, alternatively from 2.95 to 16.7, alternatively from 3.0 to 15, alternatively from 3.66 to 10.5; (vi) a loading of the tetrahydrofuran/ethanol modifier of from 15 to 45 wt %, alternatively from 18 to 39 wt %, alternatively from 20.0 to 35.0 wt %.

Carrier material in some embodiments of the modified spray-dried Ziegler-Natta primary catalyst system consists essentially of, alternatively consists of, the hydrophobic pre-treated fumed silica, which means it contains from 0 to 5 weight percent (wt %), alternatively 0 to 0.9 wt %, alternatively 0 to 0.09 wt %, alternatively 0 wt % porous silica. Without wishing to be bound by theory, we believe that the exterior surfaces of the hydrophobic pre-treated fumed silica largely define the construction of the modified spray-dried Ziegler-Natta primary catalyst system.

In the modified spray-dried Ziegler-Natta primary catalyst system the tetrahydrofuran/ethanol modifier has a THF/EtOH weight/weight ratio of from 25:75 to 75:25, alternatively from 30.0:70.0 to 70.0:30.0, alternatively from 35:65 to 65:35, alternatively from 40.0:60.0 to 60.0:40.0, alternatively from 45:55 to 55:45, alternatively from 47:53 to 53:47, alternatively 50:50.

Other components in the polymerization reaction and their concentration vary depending on the type of polymerization that is used. The polymerization may take place in a liquid phase, slurry phase or gas phase process. All three polymerization methods are well-known.

In a gas phase polymerization process, a continuous cycle may be employed, wherein in one part of the cycle of a reactor system, a cycling gas stream, otherwise known as a recycle stream or fluidizing medium, is heated in the reactor by the heat of polymerization. This heat may be removed from the cycling gas stream in another part of the cycle by a cooling system external to the reactor. Generally, in a gas fluidized bed process for producing polymers, a gaseous stream containing one or more monomers may be continuously cycled through a fluidized bed in the presence of a catalyst under reactive conditions. The gaseous stream may be withdrawn from the fluidized bed and recycled back into the reactor. Simultaneously, polymer product may be withdrawn from the reactor and fresh monomer is added to replace the polymerized monomer. In some embodiments, a diluent is added to the gas-phase polymerization to help control reaction rate and temperature in the reactor. Diluents are generally inert under polymerization conditions. Common diluents include nitrogen and alkanes containing 4-10 carbon atoms. Gas phase polymerization process are described in more detail in, for example, U.S. Pat. Nos. 4,543,399, 4,588,790, 5,028,670, 5,317,036, 5,352,749, 5,405,922, 5,436,304, 5,453,471, 5,462.999, 5,616,661, and 5,668,228.

The reactor pressure in a gas phase process may vary, for example, from about atmospheric pressure to about 600 psig, or from about 100 psig (690 kPa) to about 500 psig (3448 kPa), or from about 200 psig (1379 kPa) to about 400 psig (2759 kPa), or from about 250 psig (1724 kPa) to about 350 psig (2414 kPa). The reactor temperature in a gas phase process may vary, for example, from about 30° C. to about 120° C., or from about 60°° C. to about 115° C., or from about 70° C. to about 110° C., or from about 70° C. to about 95° C.

Additional examples of gas phase processes that may be used include those described in U.S. Pat. Nos. 5,627,242, 5,665,818 and 5,677,375, and European publications EP A-0 794 200, EP-A-0 802 202, EP-A2 0 891 990, and EP-B-634 421.

In a slurry polymerization, a suspension of solid, particulate polymer may be formed in a liquid polymerization diluent medium to which ethylene and comonomers and often hydrogen along with catalyst are added. Pressures may range from about 1 to about 50 atmospheres and temperatures may range from about 0°° C. to about 120° C. The suspension including diluent may be intermittently or continuously removed from the reactor, after which the volatile components are separated from the polymer and recycled, optionally after a distillation, to the reactor. The liquid diluent employed in the polymerization medium may typically be an alkane having from 3 to 7 carbon atoms, and in many embodiments is a branched alkane. The medium employed should be liquid under the conditions of polymerization and substantially inert under polymerization conditions. When a propane medium is used the process should be operated, for example, above the reaction diluent critical temperature and pressure. In some embodiments, a hexane or an isobutane medium is employed.

In general, a solution phase polymerization process occurs in one or more well-stirred reactors such as one or more loop reactors or one or more spherical isothermal reactors at a temperature in the range of from 120° C. to 300° C.; for example, from 160° C. to 215° C., and at pressures in the range of from 300 psi to 1500 psi; for example, from 400 psi to 750 psi. The residence time in solution phase polymerization process is typically in the range of from 2 to 30 minutes (min); for example, from 10 to 20 min. Ethylene, one or more solvents, one or more catalyst systems, and optionally one or more comonomers are fed continuously to the one or more reactors. Exemplary solvents include, but are not limited to, isoparaffins. For example, such solvents are commercially available under the name Isopar E from ExxonMobil Chemical Co. The resultant mixture of the ethylene based polymer and solvent is then removed from the reactor and the ethylene based polymer is isolated. Solvent is typically recovered via a solvent recovery unit, i.e., heat exchangers and vapor liquid separator drum, and is then recycled back into the polymerization system. Examples of solution phase polymerization are described in Patent Application WO 2017/058981 A1.

In many embodiments, polymerization takes place in a gas phase in a fluidized-bed gas-phase polymerization reactor (FB-GPP reactor). Such reactors and methods are well-known in the art. For example, FB-GPP reactors and methods are as described in the following patent publications: U.S. Pat. Nos. 3,709,853; 4,003,712; 4,011,382; 4,302,566; 4,543,399; 4,882,400; 5,352,749; 5,541,270; US 2020/0024376 A1, US 2020/024376 A1, US 2018/0155473 A1, and WO 2016/172279 A1.

The best operating conditions to produce the polymers of this invention vary depending on the reactor that is used, the catalyst system that is used, and the specific properties desired for the LLDPE copolymer. The following discussion describes ordinary conditions for common FB-GPP reactors using the catalyst system described above:

In some embodiments, the ethylene partial pressure in the reactor is at least 690 kPa (100 psia) or at least 830 kPa (120 psia) or at least 1300 kPa (190 psia). In some embodiments, the ethylene partial pressure in the reactor is at most 2070 kPa (300 psia) or at most 1720 kPa (250 psia) or at most 1590 kPa (230 psia).

In some embodiments, the bed temperature in the reactor is at least 70° C., or at least 80° C. or at least 85° C. In some embodiments, the bed temperature in the reactor is at most 110° C. or at most 100° C. or at most 95° C.

In many embodiments, the flow of reactants through the reactor is at a rate sufficient to maintain the bed of the reactor in a fluidized state.

Optionally, an inert liquid (called an induced condensing agent (ICA)) may be added to the reactor to assist in cooling the reactor. Examples of the ICA include a (C₅ to C₂₀) alkane, which may be a (C₅ to C₁₀) alkane or may be pentane or 2-methylbutane (i.e., isopentane). Use of ICA is described in the following patent publications, which are incorporated herein by reference: U.S. Pat. Nos. 4,453,399; 4,588,790; 4,994,534. In some embodiments, the concentration of ICA is at least 1 mole percent or at least 3 mole percent. In some embodiments, the concentration of ICA is at most 20 mole percent or at most 8 mole percent.

Optionally, a continuity additive may be added to the reactor to control sheeting in the reactor. Suitable continuity additives are commercially available from Univation Technologies LLC as CA-200 and CA-300. In some embodiments, the concentration of continuity additive is at least 0.5 ppmw or at least 30 ppmw. In some embodiments, the concentration of continuity additive is at most 200 ppmw or at most 80 ppmw. For some embodiments, the continuity additive may be unnecessary.

The polymerization mixture may optionally include one or more additives such as a chain transfer agent or a promoter. The chain transfer agents are well known and may be alkyl metal such as diethyl zinc. Promoters are known such as in U.S. Pat. No. 4,988,783 and may include chloroform, CFCl₃, trichloroethane, and difluorotetrachloroethane. Prior to reactor start up, a scavenging agent may be used to react with moisture and during reactor transitions a scavenging agent may be used to react with excess activator. Scavenging agents may be a trialkylaluminum. Gas phase polymerizations may be operated free of (not deliberately added) scavenging agents. The polymerization conditions for gas phase polymerization reactor/method may further include an amount (such as 0.5 to 200 ppm based on all feeds into reactor) of a static control agent and/or a continuity additive such as aluminum stearate or polyethyleneimine. The static control agent may be added to the FB-GPP reactor to inhibit formation or buildup of static charge therein.

### Description of the LLDPE Copolymer

The LLDPE copolymer of the present invention is a collection of macromolecules that comprise repeating units derived from ethylene monomer, 1-butene comonomer and other monomers used in the reaction. In some embodiments, the repeating units in the LLDPE copolymer consist essentially of units derived from ethylene monomer and 1-butene comonomer.

The LLDPE copolymer of the present inventions has a density from 0.91 g/mL to 0.93g/mL. In some embodiments, the density is at least 0.913 g/mL or at least 0.915 g/mL or at least 0.917 g/mL. In some embodiments, the density is at most 0.927 g/mL or at most 0.925 g/mL or at most 0.922 g/mL or at most 0.920 g/mL.

LLDPE copolymers are often characterized based on the viscosity of the molten polymer. The LLDPE copolymers of this invention have a melt index (I₂) from 0.5 g/10 min. to 2.7 g/10 min. In some embodiments, the melt index of LLDPE copolymers of this invention is at least 0.7 g/10 min. or at least 0.8 g/10 min. or at least 0.9 g/10 min. In some embodiments, the melt index of LLDPE copolymers of this invention is at most 2.6 g/10 min. or at most 2.5 g/10 min. or at most 2.45 g/10 min.

In some embodiments, the flow index (I₂₁) of LLDPE copolymers of this invention is at least 20 g/10 min. or at least 25 g/10 min. or at least 27 g/10 min. In some embodiments, the flow index (I₂₁) of LLDPE copolymers of this invention is at most 80 g/10 min. or at most 70 g/10 min. or at most 60 g/10 min.

In some embodiments, the melt flow ratio (I₂₁/I₂) of LLDPE copolymers of this invention is at least 15 or at least 20 or at least 22. In some embodiments, the melt flow ratio (I₂₁/I₂) of LLDPE copolymers of this invention is at most 40 or at most 35 or at most 30.

In some embodiments, the number-average molecular weight (Mₙ) of the LLDPE copolymer is at least 20,000 or at least 22,000 or at least 23,000. In some embodiments, the number-average molecular weight (Mₙ) of the LLDPE copolymer is at most 40,000 or at most 35,000 or at most 30,000.

In some embodiments, the weight-average molecular weight (M_{w}) of the LLDPE copolymer is at least 80,000 or at least 90,000 or at least 100,000. In some embodiments, the weight-average molecular weight (M_{w}) of the LLDPE copolymer is at most 200,000 or at most 150,000 or at most 140,000.

In some embodiments, the Z-average molecular weight (M_{z}) of the LLDPE copolymer is at least 300,000 or at least 350,000 or at least 380,000. In some embodiments, the Z-average molecular weight (M_{z}) of the LLDPE copolymer is at most 700,000 or at least 600,000 or at least 580,000. The average molecular weights listed above are measured by GPC as described in this application.

The polydispersity index of the LLDPE copolymer (also called “molecular weight distribution” and measured as M_{w}/Mₙ) is at least 4.25. In some embodiments, polydispersity index of the LLDPE copolymer is at least 4.3 or at least 4.4. In some embodiments, polydispersity index of the LLDPE copolymer is at most 6 or at most 5 or at most 4.75.

The ratio M_{z}/M_{w} for the LLDPE copolymer is at least 3.2. In some embodiments, the ratio M_{z}/M_{w} for the LLDPE copolymer is at least 3.45 or at least 3.5 or at least 3.6 or at least 3.7. In some embodiments, the ratio M_{z}/M_{w} for the LLDPE copolymer is at most 5 or at most 4.5 or at most 4.2.

In some embodiments, at least 1 weight percent of repeating units in the LLDPE copolymer are derived from butene, or at least 2 weight percent, or at least 4 weight percent or at least 6 weight percent. In some embodiments, at most 15 weight percent of repeating units in the LLDPE copolymer are derived from butene, or at most 12 weight percent, or at most 10 weight percent or at most 8 weight percent.

Comonomer content in LLDPE copolymers is often described in terms of short-chain branches (SCB) per 1000 carbon atoms. The short chain branches often represent units derived from the comonomer such as butene. In some embodiments, LLDPE copolymers of this invention have at least 2 SCB per 1000 carbon atoms or at least 5 SCB per 1000 carbon atoms or at least 10 SCB per 1000 carbon atoms or at least 14 SCB per 1000 carbon atoms. In some embodiments, LLDPE copolymers of this invention have at most 35 SCB per 1000 carbon atoms or at most 30 SCB per 1000 carbon atoms or at most 25 SCB per 1000 carbon atoms or at most 20 SCB per 1000 carbon atoms.

The “Molecular Weight Comonomer Distribution Index” (MWCDI) of LLDPE copolymers of the present invention is from-1.0 to-0.1. In some embodiments, the MWCDI in LLDPE copolymers of the present invention is at least-0.9 or at least-0.85. In some embodiments, the MWCDI in LLDPE copolymers of the present invention is at most-0.2 or at most-0.25. The MWCDI is calculated based on polymers with a weight average molecular weight from 10,000 to 100,000 g/mol.

Comonomer contents and molecular weight profile can also be determined through elution fractionation using the “Improved Comonomer Content Distribution” (ICCD) Analysis, which is described in US Patent Publication 2021/0040295 A1 (Para. [0171]-[0181]) and in the publication: Cong et al., A New Technique for Characterizing Comonomer Distribution in Polyolefins: High-Temperature Thermal Gradient Interaction Chromatography (HT-TGIC), 44 Macromolecules 3062-3072 (Mar. 28, 2011). In some embodiments of the LLDPE copolymer, iCCD analysis shows that polymer fractions eluting at a temperature between 93° C. and 119° C. make up no more than 23 weight percent of the LLDPE copolymer, or no more than 21 weight percent or no more than 19 weight percent. In some embodiments of the LLDPE copolymer, iCCD analysis shows that polymer fractions eluting at a temperature between 93° C. and 119° C. make up at least 10 weight percent of the LLDPE copolymer, or at least 13 weight percent or at least 15 weight percent.

LLDPE copolymers used in film applications are commonly tested for flexibility and hot tack strength.

Storage modulus (G′) and loss modulus (G″) of the LLDPE copolymers of this invention can be measured using the dynamic mechanical spectroscopy (DMS) method described in the test methods section. When measured by this method, LLDPE copolymers of this invention have a storage modulus (G′) from 90 to 115 Pa at the point in the G′-G″ curve where the loss modulus (G″) is equal to 1000 Pa,. In some embodiments of the LLDPE copolymer, the storage modulus (G′) (at the point where loss modulus (G″)=1000 Pa) is at least 92 Pa or at least 94 Pa or at least 96 Pa or at least 98 Pa. In some embodiments of the LLDPE copolymer, the storage modulus (G′) (at the point where loss modulus (G″)=1000 Pa) is at most 113 Pa or at most 111 Pa or at most 109 Pa.

The ratio of loss modulus/storage modulus (G″/G′) is called tan δ. Tan δ changes depending on the frequency at which dynamic mechanical spectroscopy is measured. The change in tan δ can be calculated by performing DMS at two different frequencies: a frequency of 0.1 radians/sec. and a frequency of 100 radians/sec. In some embodiments of the LLDPE copolymer, the ratio of tan δ at 0.1 rad/s and 100 rad/s is at least 11 or at least 12 or at least 13. In some embodiments of the LLDPE copolymer, the ratio of tan δ at 0.1 rad/s and 100 rad/s, is at most 17 or at most 15 or at most 14.

In some embodiments, LLDPE polymers of this invention have good hot-tack strength when welded at temperatures of about 100° C.

LLDPE copolymers of the present invention have a combination of traits that is particularly suitable for use in films. The melt characteristics of the polymer make them easily processable. The molecular weight profile and viscoelasticity of the resins makes them strong and flexible.

### Pelleting and Oxygen Treatment

The LLDPE copolymer typically is recovered from the reactor as copolymer granules. The granules may be converted to pellets, such as by extrusion as strands that are subsequently cut into pellets. In the extrusion process, additives may be added such as stabilizers, plasiticizers and anti-block agents. Further, in the extrusion process, the LLDPE copolymer may be “oxygen tailored” by exposure to an oxygen-containing gas such as air in the extruder. Extrusion with oxygen tailoring is described in U.S. Pat. No. 7,892,466B2. In some embodiments, the LLDPE copolymer is not oxygen-treated.

### Film

The LLDPE copolymer granules or pellets may be formed into shaped articles. One common shaped article is a film. The film may be made using any extrusion or co-extrusion methods including blown film, tentered film, and cast film methods. Film extrusion equipment is commercially available, and its use is well-known. In some embodiments, the film is made using blown film extrusion. In blown-film extrusion, the LLDPE copolymer is extruded through an annular die and stretched by passing over a bubble of air or inert gas.

The film may be unoriented, uniaxially oriented, or biaxially oriented. The uniaxially film may be oriented in the direction of extrusion (machine direction or MD), alternatively in the direction transverse to the direction of extrusion (transverse direction or TD). The biaxially oriented film may be oriented in both MD and TD by stretching or pulling in the MD, simultaneously or followed by stretching or pulling in the TD.

The resulting film may be a monolayer film, or the LLDPE copolymers may be extruded as a layer in a multilayer film or laminate. In some embodiments, the film thickness is at least 0.0051 mm (0.200 mil) or at least 0.0077 mm (0.300 mil). In some embodiments, the film thickness is at most 0.051 mm (2 mils) or at most 0.0254 mm (1.00 mils) or at most 0.0203 mm (0.80 mils) or at most 0.0152 mm (0.6 mils).

Film additives may optionally be added to the LLDPE copolymer during the pelleting step or in the extruder during film formation. A “film additive” is a compound or material other than a polyolefin polymer that imparts one or more properties to, and/or enhances one or more properties of, the blown film. Examples of film additives are antimicrobial agents, antioxidants, catalyst neutralizers (of single site catalysts), colorants, and light stabilizers. Some species of blown films contain or consist essentially of the LLDPE copolymer, at least one antioxidant, and at least one catalyst neutralizer.

The film is useful for making containers and wraps used in numerous food and non-food packaging applications. Examples of such containers are bags such as ice bags and grocery bags. Examples of such wraps are stretch films, meat wraps, and food wraps. The inventive LLDPE copolymer is also useful in a variety of non-film related applications including in vehicle parts.

In some embodiments, films made from the LLDPE copolymers of the present invention may have a hot tack strength that is at least 0.90 N or at least 1.0 N or at least 1.1 N or at least 1.2 N, when welded at 90° C. and tested according to the test set out in the end of the Examples.

### Numbered Aspects of Certain Embodiments of the Invention

The present invention may include any of the following numbered aspects:

A linear low density polyethylene (LLDPE) copolymer, comprising units derived from ethylene monomer and butene monomer, wherein:
(a) The density of the LLDPE copolymer is from 0.910 g/mL to 0.930 g/mL; and
(b) The melt index (I₂) of the LLDPE copolymer is from 0.5 g/10 min to 2.7 g/10 min; and
(c) The molecular weight distribution (Mw/Mn) of the LLDPE copolymer is at least 4.25; and.
(d) The Mz/Mw ratio of the LLDPE copolymer is at least 3.2; and
(e) The molecular weight comonomer distribution index of the LLDPE copolymer is from −0.1 to −1.0; and
(f) The storage modulus (G′) of the material is from 90 Pa to 115 Pa when the loss modulus (G″) is 1000 Pa.

2. The LLDPE copolymer of Embodiment 1, which contains from 5 to 30 short chain branches per 1000 carbon atoms.

3. The LLDPE copolymer of any one of Embodiments 1 or 2 wherein repeating units in the LLDPE copolymer consist essentially of units derived from ethylene and units derived from butene.

4. The LLDPE copolymer of any one of Embodiments 1 through 3 wherein the density of the LLDPE copolymer is from 0.915 g/cm³ to 0.925 g/cm³.

5. The LLDPE copolymer of any one of Embodiments 1 through 4 wherein the melt index of the LLDPE copolymer is from 0.8 g/10 min. to 2.5 g/10 min.

6. The LLDPE copolymer of any one of Embodiments 1 to 5 wherein the polydispersity index (Mw/Mn) of the LLDPE copolymer is from 4.3 to 5.

7. The LLDPE copolymer of any one of Embodiments 1 to 6 wherein the Mz/Mw ratio of the LLDPE copolymer is from 3.6 to 4.5.

8. The LLDPE copolymer of any one of Embodiments 1 to 7 wherein the molecular weight comonomer distribution index of the LLDPE copolymer is from −0.2 to −0.9.

9. The LLDPE copolymer of any one of Embodiments 1 to 8, wherein the elastic modulus (G′) of the LLDPE copolymer is from 94 Pa to 111 Pa when the loss modulus (G″) is 1000 Pa.

10. The LLDPE copolymer of any one of Embodiments 1 to 9, wherein the LLDPE copolymer has a ratio of tan δ at 0.1 rad/sec. over tan δ at 100 rad/sec. that is no more than 14.

11. The LLDPE copolymer of any one of Embodiments 1 to 10 wherein the LLDPE copolymer was made in a process comprising a gas-phase polymerization using a catalyst system comprising a Ziegler-Natta catalyst system.

12. The LLDPE copolymer of Embodiment 11 wherein the Ziegler-Natta catalyst system used to make the LLDPE copolymer contains a tetrahydrofuran/ethanol modifier.

13. A film comprising the LLDPE copolymer of any one of Embodiments 1 to 12, the film having a thickness of 0.0077 millimeters (mm) to 0.254 mm.

14. A film of Embodiment 13 which has a hot tack strength of at least 1.0 N when welded at 90° C. and tested according to ASTM F-1921 (Method B).

15. A process to make a film comprising the steps of
(a) melting the LLDPE copolymer of any one of claims 1 to 12 to give a melt thereof,
(b) extruding the melt through a die configured for forming a bubble to make a bubble of the LLDPE copolymer,
(c) blowing the bubble with a film-blowing machine, thereby making the blown film; and
(d) cooling the blown film.

### EXAMPLES

An activated catalyst composition is synthesized as described in the Inventive Examples of Modified Spray-Dried Ziegler-Natta (Pro)Catalyst Systems, PCT Publication 2019/112929 A1 (13 Jun. 2019).

The catalyst is used to polymerize the reaction of ethylene and 1-butene in two individual gas phase fluidized bed reactors. For Inventive Example 1 (or IE1), the reactor is a pilot scale reactor having a production capacity of from 10 to 35 kg/hour. For Inventive Example 2 or (IE2) polymer is made in a production scale reactor at a rate of 7000 lbs per hour. At the beginning of the reaction, each reactor is transitioned from production of a comparable ethylene-butene copolymer having comparable density and melt index that is being made using a Ziegler-Natta catalyst; the comparable ethylene-butene forms the seed bed at the start of the reaction. Reaction conditions are described in Table 1.

A comparative example (Comparative Example A or CE A) is made using the same equipment and general process scheme as Inventive Example 2.

TABLE 1
Operating conditions for IE1, IE2.

| | | | Comparative |
|---|---|---|---|
| | Example 1 | Example 2 | Example A |
| Reactor Information | | | |
| Reactor Capacity (lb/hr) | 22-77 | | |
| Production Rate [lb/h] | 30.9 | 7000 | 9000 |
| Bed Weight [lb] | 78.4 | 32170 | 31254 |
| Bed Height [ft] | 6.16 | 39.6 | 40.1 |
| Bed Volume (ft³) | 5.89 | | |
| Residence Time [h] | 1.88 | 4.6 | 3.5 |
| Lower Fluidized Bulk Density [lb/ft3] | 13.3 | 16.6 | 16.3 |
| Mid Fluidized Bulk Density [lb/ft3] | 13.3 | 16.7 | 16.7 |
| Reactor Pressure [psig] | 345 | 245 | 243 |
| Superficial Gas Velocity [ft/s] | — | 1.78 | 1.77 |
| C₂ Partial Pressure [psia] | 99.7 | 99.6 | 100.2 |
| Bed Temperature SP [° C.] | — | 85.6 | 85.9 |
| Bed Temperature [° C.] | 88.0 | 85.6 | 85.6 |
| Inlet Gas Temperature [° C.] | — | 48.2 | 30.9 |
| H₂/C₂ Ratio [mol/mol] | 0.0953 | 0.139 | 0.156 |
| C₄/C₂ Ratio [mol/mol] | 0.364 | 0.454 | 0.386 |
| Catalyst Information | | | |
| Slurry Catalyst Feed Rate | 3.5 cc/hr | 0.76 lb/h | 1.82 lb/h |
| Slurry Catalyst % Solids | | 17.5 | 17.6 |
| Wt % Ti on Catalyst Solids | | 2.5 | 2.3 |
| Slurry Catalyst Solids Productivity [lb/lb] | | 52500 | 28000 |
| Cocatalyst Concentration (wt %) | 2.5 | | |
| Total TEAI Feed Rate | 206 cc/hr | 3.5 lb/h | 6.8 lb/hr |
| Al/Ti Ratio [mol/mol] | | 43 | 38 |
| Feeds and Gas Composition | | | |
| C2 Feed [lb/h] | | 6616 | 8882 |
| H2 Feed [lb/h] | | 6.1 | 6.9 |
| C4 Feed [lb/h] | | 1396 | 1442 |
| Vent Flow (Low) [lb/h] | | 3.4 | 4.3 |
| Vent Flow (High) [lb/h] | | 100 | 101 |
| C2 Mol % | | 38.43 | 38.89 |
| C4 Mol % | | 17.54 | 14.99 |
| H2 Mol % | | 5.34 | 6.09 |
| IC5 Mol % | | 0.06 | 0.12 |
| N2 Mol % | | 38.24 | 39.98 |
| Product Information | | | |
| QC Density [g/cc] | 0.9177 | 0.9172 | 0.9171 |
| Melt Index (2.16 kg) [dg/min] | 0.9984 | 2.09 | 1.96 |
| Settled Bulk Density [lb/ft3] | 21.51 | 22.19 | 21.7 |
| Average Particle Size [in.] | — | 0.0263 | 0.0363 |

Granular copolymer is recovered from the reactors and purged with nitrogen. Certain properties of the granular copolymer are measured using the test methods described at the end of these Examples and reported in Table 1 as “Product Information”.

The remaining granular copolymer is pelletized. The following additives are added to the pelletized samples: Preblend 9K (BASF) 1300 ppm; Irgafos® 168 (BASF) 600 ppm. Properties of the pelletized copolymers are measured using the test methods described at the end of these Examples. Results are reported below in Table 2. As further comparative, one commercial LLDPE resin ExxonMobil™ LLDPE LL 1002AY that is commonly used to make films is acquired and tested.

TABLE 2

| | | | I₂ | I₂₁ | | GPC | GPC | GPC | | | |
|---|---|---|---|---|---|---|---|---|---|---|---|
| | | Density | g/10 | g/10 | | Mn | Mw | Mz | GPC | GPC | |
| | | g/cc | min | min | I₂₁/I₂ | g/mol | g/mol | g/mol | Mw/Mn | Mz/Mw | MWCDI |
| Inventive | Example 1 | 0.918 | 1.0 | 28.1 | 28.1 | 29,017 | 134,181 | 555,410 | 4.62 | 4.14 | −0.83 |
| | Example 2 | 0.918 | 2.4 | 58.5 | 24.4 | 23,472 | 103,676 | 391,454 | 4.42 | 3.78 | −0.27 |
| Comparative | LL 1002AY | 0.920 | 2.1 | 49.2 | 24.0 | 26,437 | 99,614 | 299,549 | 3.77 | 3.01 | −0.09 |
| | Example A | 0.919 | 1.8 | 46.8 | 26.1 | 25,504 | 107,065 | 375,469 | 4.20 | 3.51 | −0.28 |

TABLE 3

| | | G′@(G″ = 1000 Pa) | | iCCD Wt % in Each Temperature Zone | | | | |
|---|---|---|---|---|---|---|---|---|
| | | Pa | Tan δ @0.1/Tan δ @100 | 25-35° C. | 35-55° C. | 55-75° C. | 75-93° C. | 93-119° C. |
| Inventive | Example 1 | 107.2 | 9.9 | 8.8% | 6.6% | 24.7% | 41.5% | 18.4% |
| | Example 2 | 98.2 | 13.7 | 10.9% | 7.7% | 26.1% | 38.8% | 16.5% |
| Comparative | LL 1002AY | 79.8 | 16.3 | 6.3% | 6.7% | 27.3% | 44.1% | 15.5% |
| | Example A | 90.3 | 14.2 | 8.6% | 7.3% | 26.8% | 41.0% | 16.3% |

The resin from inventive example 2 is fabricated into a 2.0 mil film. Film is made on a film line with DSBII 3.5 inch diameter and 30 L/D ratio screw, 8 inch die diameter and 70 mil die gap, 2.5 blow up ratio at 250 lbs/hr output rate The resin from Comparative Example A and ExxonMobil™ LLDPE LL 1002AY are also fabricated into 2.0 mil films.

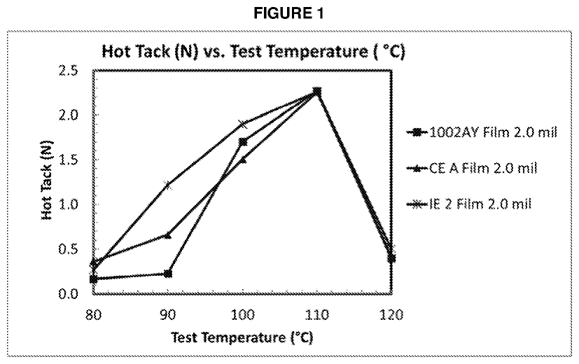

The hot tack strength of the films is tested using the test methods described below. The results are shown in FIG. 1.

The inventive examples show superior elastic modulus and hot tack strength. They also have a broad molecular weight distribution, which is associated with better processability.

TABLE 4
Test Methods

| Measurement | Test Method |
|---|---|
| Density | ASTM D792-13, Standard Test Methods for Density and Specific |
| | Gravity (Relative Density) of Plastics by Displacement, Method B |
| | (for testing solid plastics in liquids other than water, e.g., in liquid |
| | 2-propanol). QC Density is measured after conditioning 10 to 15 min |
| | and density is measured after conditioning at least 40 hours. |
| Melt Index (“I₂”) | ASTM D1238-13, Standard Test Method for Melt Flow Rates of |
| | Thermoplastics by Extrusion Platometer, using conditions of |
| | 190° C./2.16 kg, formerly known as “Condition E”. |
| Flow Index (I₂₁) | ASTM D1238-13, Standard Test Method for Melt Flow Rates of |
| | Thermoplastics by Extrusion Platometer, using conditions of |
| | 190° C./21.6 kilograms (kg) |
| Short Chain | ASTM 5017-17, Standard Test Method for Determination of |
| Branching/Comonomer | Linear Low Density Polyethylene (LLDPE) Composition by |
| Content | Carbon-13 Nuclear Magnetic Resonance, ASTM International, |
| | West Conshohocken, PA, 2017, www.astm.org. Other useful |
| | publications include: ASTM D 5017-96; J. C. Randall et al., “NMR |
| | and Macromolecules” ACS Symposium series 247; J. C. Randall, |
| | Ed., Am. Chem. Soc., Washington, D.C., 1984, Ch. 9, and J. C. |
| | Randall in “Polymer Sequence Determination”, Academic Press, |
| | New York (1977). |
| Molecular Weight | Determined by Gel Permeation Chromatography as described |
| (Mₙ, M_{w} and M_{z}) | below. |
| Storage Modulus | The samples were compression molded into a disk for rheology |
| (G′), Loss Modulus | measurement. The disks were prepared by pressing the samples |
| (G), Tan δ | into 0.071″ (1.8 mm) thick plaques, which were subsequently cut into |
| | 1 inch (25.4 mm) diameter disks. The compression molding |
| | procedure was as follows: 365° F. (185° C.) for 5 min at 1500 psi |
| | (10.3 MPa); cooling at 27° F. (15° C.)/min to ambient temperature |
| | (approximately 30° C.). |
| | The rheology was measured on an ARES-G2 Rheometer, a |
| | strain-controlled rheometer commercialized by TA instruments. A |
| | rotary actuator (servomotor) applies shear deformation in the form of |
| | strain to a sample. In response, the sample generates torque, which |
| | is measured by the force rebalance transducer. Strain and torque |
| | are used to calculate dynamic mechanical properties, such as |
| | modulus and viscosity. The viscoelastic properties of the sample |
| | were measured in the melt using a parallel plate set up at constant |
| | strain and temperature (190° C.), and as a function of varying angular |
| | frequency (0.1 to 100 rad/s−1). The storage modulus (G′) at loss |
| | modulus (G″ = 1000 pa), damping factor (tan δ) at 0.1 rad/s and at |
| | 100 rad/s, the ratio of tan δ at 0.1 rad/s and 100 rad/s of the resin |
| | were determined by Trios software. All experiments were conducted |
| | in a nitrogen environment. |
| Hot Tack Strength | Hot tack measurements on the film are performed using an Enepay |
| | commercial testing machines according to ASTM F-1921 (Method |
| | B). Prior to testing the samples are conditioned for a minimum of |
| | 40 hrs at 23° C. and 50% R.H. The hot tack test simulates the filling of |
| | material into a pouch or bag before the seal has had a chance to |
| | cool completely. |
| | Sheets of dimensions 8.5″ by 14″ are cut from the film, with the |
| | longest dimension in the machine direction. Strips 1″ wide and 14″ |
| | long are cut from the film [samples need only be of sufficient length |
| | for clamping]. Tests are performed on these samples over a range of |
| | temperatures and the results reported as the maximum load as a |
| | function of temperature. Typical temperature steps are 10° C. with 6 |
| | replicates performed at each temperature. The typical parameters |
| | used in the test are as follows: |
| | Specimen Width: 25.4 mm (1.0 in) |
| | Sealing Pressure: 0.275 N/mm2 |
| | Sealing Dwell Time: 1.0 s |
| | Peel speed: 200 mm/s |
| | Seal depth = 0.5 inch |
| | The data are reported as a hot tack curve where Average Hot Tack |
| | Force (N) is plotted as a function of temperature. |

### Molecular Weight

Molecular weights, including peak molecular weight (M_{p(GPC)}), weight average molecular weight (M_{w(GPC)}), number average molecular weight (M_{n(GPC)}), and z-average molecular weight (M_{z(GPC)}), are measured using conventional Gel Permeation Chromatography (GPC) and are reported in grams per mole (g/mol).

The chromatographic system is a PolymerChar GPC-IR (Valencia, Spain) high temperature GPC chromatograph equipped with an internal IR5 infra-red detector (IR5). The autosampler oven compartment is set at 160° C. and the column compartment is set at 150° C. The columns used are four Agilent “Mixed A” 30 centimeter (cm) 20-micron linear mixed-bed columns. The chromatographic solvent used is 1,2,4 trichlorobenzene containing 200 parts per million (ppm) of butylated hydroxytoluene (BHT). The solvent source is nitrogen sparged. The injection volume used is 200 microliters (μl) and the flow rate is 1.0 milliliters/minute (ml/min).

Calibration of the columns is performed with at least 20 narrow molecular weight distribution polystyrene standards with molecular weights ranging from 580 to 8,400,000 g/mol. Standards are arranged in 6 “cocktail” mixtures with at least a decade of separation between individual molecular weights. The standards are purchased from Agilent Technologies. The standards are prepared at 0.025 grams in 50 milliliters of solvent for molecular weights equal to or greater than 1,000,000 g/mol, and 0.05 grams in 50 milliliters of solvent for molecular weights less than 1,000,000 g/mol. The standards are dissolved at 80° C. with gentle agitation for 30 minutes. The standard peak molecular weights are converted to ethylene-based polymer molecular weights using Equation 1 (as described in Williams and Ward, J. Polym. Sci., Polym. Let., 6, 621 (1968)):

$$\text{?} = A \times {( \text{?} )}^{B} \qquad Equation 1$$

$$\text{?} \text{indicates text missing or illegible when filed}$$

where M is the molecular weight, A has a value of 0.4315, and B is equal to 1.0.

A fifth-order polynomial is used to fit the respective ethylene-based polymer-equivalent calibration points. (In our examples, a minor adjustment to A (from approximately 0.39 to 0.44) is needed to correct for column resolution and band-broadening effects such that NIST standard NBS 1475 is obtained at a molecular weight of 52,000 g/mol.)

The total plate count of the columns is performed with eicosane (prepared at 0.04 grams in 50 milliliters of TCB and dissolved with gentle agitation for 20 minutes). The plate count (Equation 2) and symmetry (Equation 3) are measured on a 200 microliter injection according to the following equations:

$$Plate Count = 5.54 \times {( \frac{{RV}_{Peak Max}}{Peak Width at half height} )}^{2} \qquad Equation 2$$

where RV is the retention volume in milliliters, peak width is in milliliters, peak max is the maximum height of the peak, and half height is one half of the height of peak max, and

$$Symmetry = \frac{( Rear Peak {RV}_{one tenth height} - {RV}_{Peak Max} )}{( {RV}_{Peak Max} - Front Peak {RV}_{one tenth height} )} \qquad Equation 3$$

where RV is the retention volume in milliliters, peak width is in milliliters, peak max is the maximum height of the peak, one tenth height is one tenth of the height of peak max, rear peak refers to the peak tail at retention volumes later than peak max, and front peak refers to the peak front at retention volumes earlier than peak max. The plate count for the chromatographic system should be greater than 22,000 and symmetry should be between 0.98 and 1.22.

Samples are prepared in a semi-automatic manner with the PolymerChar “Instrument Control” Software, wherein the samples are weight-targeted at 2 milligrams per milliliter (mg/ml), and the solvent, which contained 200 ppm BHT, is added to a pre nitrogen-sparged septa-capped vial, via the PolymerChar high-temperature autosampler. The samples are dissolved under “low speed” shaking for 3 hours at 160° C.

The calculations of M_{n(GPC)}, M_{w(GPC)}, and M_{z(GPc)} are based on GPC results using the internal IR5 detector (measurement channel) of the PolymerChar GPC-IR chromatograph according to Equations 4-7, using PolymerChar GPCOne™ software, the baseline-subtracted IR chromatogram at each equally-spaced data collection point i (IRᵢ) and the ethylene-based polymer equivalent molecular weight obtained from the narrow standard calibration curve for the point i (M_{polyethylene,i} in g/mol) from Equation 1. Subsequently, a GPC molecular weight distribution (GPC-MWD) plot (wt_{GPC}(IgMW)) vs. IgMW plot, where wt_{GPC}(IgMW) is the weight fraction of ethylene-based polymer molecules with a molecular weight of IgMW for the ethylene-based polymer sample can be obtained. Molecular weight (MW) is in g/mol and wt_{GPC}(IgMW) follows the Equation 4.

$$\int {wt}_{GPC} ( lg MW ) dlg MW = 1. \qquad Equation 4$$

M_{n(GPC)}, M_{w(GPC)} and M_{z(GPC)} are calculated by the following equations:

$${Mn}_{( GPC )} = \frac{{\sum }^{i} {IR}_{i}}{{\sum }^{i} ( {IR}_{i} / {M}_{polyethylene {,}_{i}} )} \qquad Equation 5$$

$${Mw}_{( GPC )} = \frac{{\sum }^{i} ( {IR}_{i} * {M}_{polyethylene {,}_{i}} )}{{\sum }^{i} {IR}_{i}} \qquad Equation 6$$

$${Mz}_{( GPC )} = \frac{{\sum }^{i} ( {IR}_{i} * {{M}_{polyethylene {,}_{i}}}^{2} )}{{\sum }^{i} ( {IR}_{i} * {M}_{polyethylene {,}_{i}} )} \qquad Equation 7$$

M_{p(GPC)} is the molecular weight at which the wt_{GPC}(IgMW) had the highest value on the GPC-MWD plot.

In order to monitor the deviations over time, a flow rate marker (decane) is introduced into each sample via a micropump controlled with the PolymerChar GPC-IR system. This flow rate marker (FM) is used to linearly correct the pump flow rate (Flowrate (nominal)) for each sample by RV alignment of the respective decane peak within the sample (RV (FM Sample)) to that of the decane peak within the narrow standards calibration (RV (FM Calibrated)). Any changes in the time of the decane marker peak are then assumed to be related to a linear-shift in flow rate (Flowrate (effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flow rate (with respect to the narrow standards calibration) is calculated as Equation 11. Processing of the flow marker peak is done via the PolymerChar GPCOne™ Software. Acceptable flow rate correction is such that the effective flowrate should be within 0.5% of the nominal flowrate.

$$Flow {rate}_{effective} = Flow {rate}_{nominal} \times ( RV ( {FM}_{calibrated} ) / RV ( {FM}_{Sample} ) ) \qquad Equation 8$$

1. A linear low density polyethylene (LLDPE) copolymer, comprising units derived from ethylene monomer and butene monomer, wherein:
(a) The density of the LLDPE copolymer is from 0.910 g/mL to 0.930 g/mL; and
(b) The melt index (I₂) of the LLDPE copolymer is from 0.5 g/10 min to 2.7 g/10 min; and
(c) The molecular weight distribution (Mw/Mn) of the LLDPE copolymer is at least 4.25; and.
(d) The Mz/Mw ratio of the LLDPE copolymer is at least 3.2; and
(e) The molecular weight comonomer distribution index of the LLDPE copolymer is from −0.1 to −1.0; and
(f) The storage modulus (G′) of the material is from 90 Pa to 115 Pa when the loss modulus (G″) is 1000 Pa.

2. The LLDPE copolymer of claim 1, which contains from 5 to 30 short chain branches per 1000 carbon atoms.

3. The LLDPE copolymer of claim 1 wherein repeating units in the LLDPE copolymer consist essentially of units derived from ethylene and units derived from butene.

4. The LLDPE copolymer of claim 1 through 3 wherein the density of the LLDPE copolymer is from 0.915 g/cm³ to 0.925 g/cm³.

5. The LLDPE copolymer of claim 1 through 4 wherein the melt index of the LLDPE copolymer is from 0.8 g/10 min. to 2.5 g/10 min.

6. The LLDPE copolymer of claim 1 wherein the polydispersity index (Mw/Mn) of the LLDPE copolymer is from 4.3 to 5.

7. The LLDPE copolymer of claim 1 wherein the Mz/Mw ratio of the LLDPE copolymer is from 3.6 to 4.5.

8. The LLDPE copolymer of claim 1 wherein the molecular weight comonomer distribution index of the LLDPE copolymer is from −0.2 to −0.9.

9. The LLDPE copolymer of claim 1, wherein the elastic modulus (G′) of the LLDPE copolymer is from 94 Pa to 111 Pa when the loss modulus (G″) is 1000 Pa.

10. The LLDPE copolymer of claim 1, wherein the LLDPE copolymer has a ratio of tan δ at 0.1 rad/sec. over tan δ at 100 rad/sec. that is no more than 14.

11. The LLDPE copolymer of claim 1, wherein the LLDPE copolymer was made in a process comprising a gas-phase polymerization using a catalyst system comprising a Ziegler-Natta catalyst system.

12. The LLDPE copolymer of claim 11 wherein the Ziegler-Natta catalyst system used to make the LLDPE copolymer contains a tetrahydrofuran/ethanol modifier.

13. A film comprising the LLDPE copolymer of claim 1, the film having a thickness of 0.0077 millimeters (mm) to 0.254 mm.

14. A film of claim 13 which has a hot tack strength of at least 1.0 N when welded at 90° C. and tested according to ASTM F-1921 (Method B).

15. A process to make a film comprising the steps of
(a) melting the LLDPE copolymer of claim 1 to give a melt thereof,
(b) extruding the melt through a die configured for forming a bubble to make a bubble of the LLDPE copolymer,
(c) blowing the bubble with a film-blowing machine, thereby making the blown film; and
(d) cooling the blown film.
